(19) United States
(12) Patent Application Publication
(10) Pub. No.: US 2019/0317532 A1
(43) Pub. Date: Oct. 17, 2019

(54) GIMBAL CONTROL METHOD, CONTROL SYSTEM, GIMBAL, AND UNMANNED AIRCRAFT

(71) Applicant: SZ DJI OSMO TECHNOLOGY CO., LTD., Shenzhen (CN)

(72) Inventor: Yan WANG, Shenzhen (CN)

(21) Appl. No.: 16/454,049

(22) Filed: Jun. 27, 2019

Related U.S. Application Data
(63) Continuation of application No. PCT/CN2016/113594, filed on Dec. 30, 2016.

(51) Int. Cl. G05D 3/20; G05D 1/00; B64D 47/08; G01D 5/12

(52) U.S. Cl. CPC G05D 3/20; G01D 5/12; B64D 47/08; G05D 1/0094

(57) ABSTRACT

A method is provided for controlling a gimbal including a mounting member. The method includes determining, through a magnetic sensor, a first deflection angle of the mounting member around a yaw axis in a time period. The method also includes determining, through an inertial measurement unit, a second deflection angle of the mounting member around the yaw axis in the time period. The method also includes determining an angle error of the inertial measurement unit based on the first deflection angle and the second deflection angle. The method further includes controlling attitude of the gimbal based on measurement data of the inertial measurement unit in which the angle error has been corrected.

### CROSS-REFERENCE TO RELATED APPLICATION

This application is a continuation application of International Application No. PCT/CN2016/113594, filed on Dec. 30, 2016, the entire content of which is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the technology field of gimbals and, more particularly, to a gimbal control method, a control system, a gimbal, and an unmanned aircraft carrying the gimbal.

### BACKGROUND

An unmanned aircraft typically carries a gimbal. The gimbal includes a mounting member configured to mount a load device such as an imaging device, to accomplish real-time photographing or other operations during a flight. Because attitude of the unmanned aircraft may change during the flight, the gimbal may control the attitude of the mounting member to make adjustments in the roll, pitch, or yaw directions to thereby maintaining the stability of the attitude of the load device.

Currently available gimbals often use fused attitude of a gyroscope and an acceleration as a reference for the attitude of the mounting member. The roll axis and the pitch axis of the mounting member may use the gravitational acceleration as the absolute reference to maintain stability of the attitude in the roll axis direction and the pitch axis direction. However, the yaw axis direction lacks an absolute attitude reference. Therefore, when a zero offset (i.e., offset from zero) or a temperature drifting occurs in the gyroscope, and the gimbal is in a locked state, the gimbal cannot maintain the mounting member stationary without rotating around the yaw axis. Typically, the mounting member keeps rotating in a direction, which is referred to as a drifting phenomenon.

### SUMMARY

In accordance with an aspect of the present disclosure, there is provided a method for controlling a gimbal including a mounting member. The method includes determining, through a magnetic sensor, a first deflection angle of the mounting member around a yaw axis in a time period. The method also includes determining, through an inertial measurement unit, a second deflection angle of the mounting member around the yaw axis in the time period. The method also includes determining an angle error of the inertial measurement unit based on the first deflection angle and the second deflection angle. The method further includes controlling attitude of the gimbal based on measurement data of the inertial measurement unit in which the angle error has been corrected.

In accordance with another aspect of the present disclosure, there is provided a gimbal. The gimbal includes a mounting member configured to mount a load device. The gimbal also includes a magnetic sensor, an inertial measurement unit, and a controller. The controller is configured to determine, through the magnetic sensor, a first deflection angle of the mounting member around a yaw axis in a time period. The controller is also configured to determine, through the inertial measurement unit, a second deflection angle of the mounting member around the yaw axis in the time period. The controller is also configured to determine an angle error of the inertial measurement unit based on the first deflection angle and the second deflection angle. The controller is further configured to control attitude of the gimbal based on measurement data of the inertial measurement unit in which the angle error has been corrected.

### BRIEF DESCRIPTION OF THE DRAWINGS

To better describe the technical solutions of the various embodiments of the present disclosure, the accompanying drawings showing the various embodiments will be briefly described. As a person of ordinary skill in the art would appreciate, the drawings show only some embodiments of the present disclosure. Without departing from the scope of the present disclosure, those having ordinary skills in the art could derive other embodiments and drawings based on the disclosed drawings without inventive efforts.

FIG. 1 is a perspective view of a gimbal mounted with an imaging device, according to an example embodiment.

FIG. 2 is a schematic diagram of a gimbal, according to an example embodiment.

FIG. 3a illustrates the principle for determining an angular error of an inertial measurement unit, according to an example embodiment.

FIG. 3b illustrates the principle for determining an angular error of an inertial measurement unit, according to an example embodiment.

FIG. 4 is a schematic diagram of a gimbal, according to another example embodiment.

FIG. 5 is a schematic diagram of a first deflection angle determination apparatus, according to an example embodiment.

FIG. 6 is a perspective view of an unmanned aircraft, according to an example embodiment.

### DETAILED DESCRIPTION OF THE EMBODIMENTS

Technical solutions of the present disclosure will be described in detail with reference to the drawings, in which the same numbers refer to the same or similar elements unless otherwise specified. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

As used herein, when a first component (or unit, element, member, part, piece) is referred to as “coupled,” “mounted,” “fixed,” “secured” to or with a second component, it is intended that the first component may be directly coupled, mounted, fixed, or secured to or with the second component, or may be indirectly coupled, mounted, or fixed to or with the second component via another intermediate component. The terms “coupled,” “mounted,” “fixed,” and “secured” do not necessarily imply that a first component is permanently coupled with a second component. The first component may be detachably coupled with the second component when these terms are used. When a first component is referred to as “connected” to or with a second component, it is intended that the first component may be directly connected to or with the second component or may be indirectly connected to or with the second component via an intermediate component. The connection may include mechanical and/or electrical connections. The connection may be permanent or detachable. The electrical connection may be wired or wireless. When a first component is referred to as “disposed,” “located,” or “provided” on a second component, the first component may be directly disposed, located, or provided on the second component or may be indirectly disposed, located, or provided on the second component via an intermediate component. When a first component is referred to as “disposed,” “located,” or “provided” in a second component, the first component may be partially or entirely disposed, located, or provided in, inside, or within the second component. The terms “perpendicular,” “horizontal,” “vertical,” “left,” “right,” “up,” “upward,” “upwardly,” “down,” “downward,” “downwardly,” and similar expressions used herein are merely intended for describing relative positional relationship.

In addition, the singular forms “a,” “an,” and “the” are intended to include the plural forms as well, unless the context indicates otherwise. The terms “comprise,” “comprising,” “include,” and the like specify the presence of stated features, steps, operations, elements, and/or components but do not preclude the presence or addition of one or more other features, steps, operations, elements, components, and/or groups. The term “and/or” used herein includes any suitable combination of one or more related items listed. For example, A and/or B can mean A only, A and B, and B only. The symbol “/” means “or” between the related items separated by the symbol. The phrase “at least one of” A, B, or C encompasses all combinations of A, B, and C, such as A only, B only, C only, A and B, B and C, A and C, and A, B, and C. In this regard, A and/or B can mean at least one of A or B. The term “module” as used herein includes hardware components or devices, such as circuit, housing, sensor, connector, etc. The term “communicatively couple(d)” or “communicatively connect(ed)” indicates that related items are coupled or connected through a communication channel, such as a wired or wireless communication channel. The term “unit” may encompass a hardware component, a software component, or a combination thereof. For example, a “unit” may include a processor, a portion of a processor, an algorithm, a portion of an algorithm, a circuit, a portion of a circuit, etc.

Further, when an embodiment illustrated in a drawing shows a single element, it is understood that the embodiment may include a plurality of such elements. Likewise, when an embodiment illustrated in a drawing shows a plurality of such elements, it is understood that the embodiment may include only one such element. The number of elements illustrated in the drawing is for illustration purposes only, and should not be construed as limiting the scope of the embodiment. Moreover, unless otherwise noted, the embodiments shown in the drawings are not mutually exclusive, and they may be combined in any suitable manner. For example, elements shown in one embodiment but not another embodiment may nevertheless be included in the other embodiment.

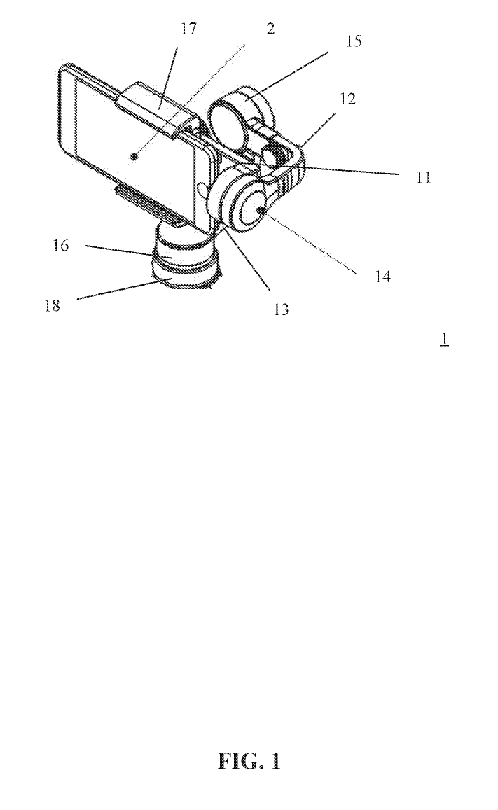

FIG. 1 is a perspective view of a gimbal 1. The gimbal 1 may include multiple connection axis arms. A load device, such as an imaging device, may be mounted on one of the axis arms. Each axis arm may be driven by a corresponding motor to cause a mounting member to move. For example, as shown in FIG. 1, the gimbal 1 may include a pitch axis arm 11, a roll axis arm 12, a yaw axis arm 13, a pitch axis motor 14, a roll axis motor 15, a yaw axis motor 16, a mounting member 17, and a base 18. In some embodiments, the mounting member 17 of the gimbal 1 may be mounted with an imaging device 2.

As shown in FIG. 1, the pitch axis arm 11, the roll axis arm 12, and the yaw axis arm 13 may be connected in sequence. The mounting member 17 may be provided on the pitch axis arm 11. The pitch axis arm 11 may be driven by the pitch axis motor 14 to cause the mounting member 17 to move in a pitch direction. The roll axis arm 12 may be driven by the roll axis motor 15 to cause the mounting member 17 to move in a roll direction, and the yaw axis arm 13 may be driven by the yaw axis motor 16 to cause the mounting member 17 to move in a yaw direction. The rotations of the pitch axis arm 11, the roll axis arm 12, and the yaw axis arm 13 may compensate for the vibration of the gimbal 1 to maintain the stability of the imaging device 2, such that the imaging device 2 may capture stable images. In some embodiments, the rotations of the pitch axis arm 11, the roll axis arm 12, and the yaw axis arm 13 may adjust attitude of the imaging device 2.

An inertial measurement unit may be provided on the mounting member 17. The inertial measurement unit may include a gyroscope configured to detect a rotation angle of the mounting member 17 around the yaw axis. In some embodiments, the inertial measurement unit and the mounting member 17 may be provided on a same rigid body. As described in the Background section, if there is no absolute attitude reference in the yaw direction, then when the zero offset or the temperature drifting causes an angle error in the gyroscope, and when the gimbal is in a locked state, the gimbal cannot maintain the mounting member stationary without rotating around the yaw axis. Typically, in conventional gimbals, the mounting member keeps rotating in a direction to generate the drifting phenomenon.

When two spatial locations are relatively close, it may be deemed that the directions of the horizontal components of the magnetic field intensity at the surface of the earth are the same. Therefore, the angle error in the inertial measurement unit, such as the angle error in the gyroscope, may be corrected based on the horizontal components of the magnetic field intensity. In some embodiments, the correction may be performed at a predetermined time interval to eliminate an accumulated error caused by the angle error of the inertial measurement unit. In the present disclosure, a magnetic field intensity at a surface of a sphere may be the geomagnetic field intensity.

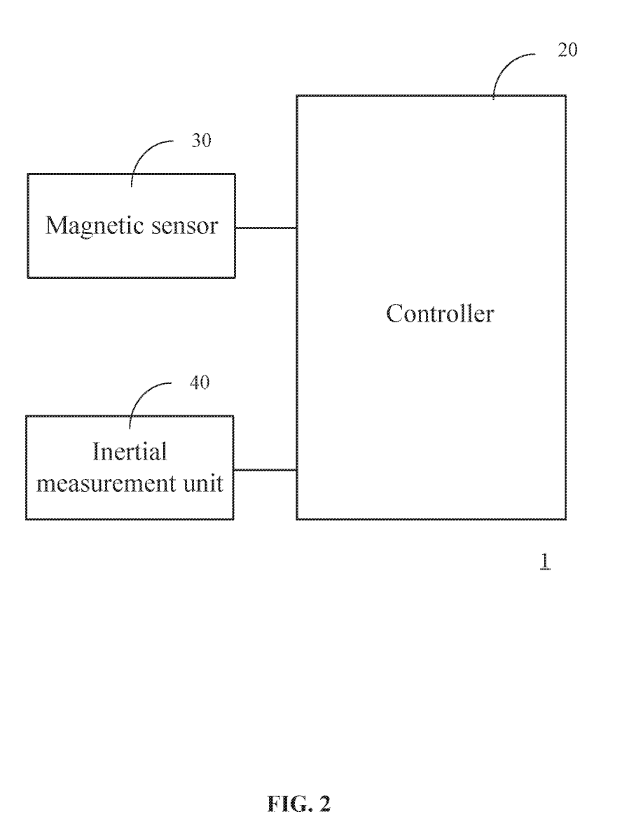

FIG. 2 is a schematic diagram of the gimbal 1. The gimbal 1 may include a controller 20, a magnetic sensor 30, and an inertial measurement unit 40. The magnetic sensor 30 may include a digital compass. The magnetic sensor 30 may be mounted to the mounting member 17. In some embodiments, the magnetic sensor 30 and the mounting member 17 may be provided on the same rigid body. For example, the magnetic sensor 30 and the mounting member 17 may be provided on the pitch axis arm 11. In some embodiments, the inertial measurement unit 40 may include at least a gyroscope. The inertial measurement unit 40 may be mounted to the mounting member 17. In some embodiments, the inertial measurement unit 40 and the mounting member 17 may be provided on the same rigid body. For example, the inertial measurement unit 40 and the mounting member 17 may be provided on the pitch axis arm 11. In some embodiments, the controller 20 and the inertial measurement unit 40 may be integrally provided.

In some embodiments, the controller 20 may include a processor and a storage device. The storage device may store computer-readable codes or instructions. The processor may execute the computer-readable codes to perform various operations or processes disclosed herein. In some embodiments, the controller 20 may include at least one of a field-programmable gate array (“FPGA”), a programmable logic array (“PLA”), system on a chip, system on a substrate, system on a package, an application-specific integrated circuit (“ASIC”), or other hardware or firmware that may integrate or package circuits in a suitable manner. In some embodiments, the controller may be realized using software, hardware, firmware, or any suitable combination thereof.

In some embodiments, the controller may obtain a first magnetic field intensity v1 through the magnetic sensor 30, determine a first deflection angle of the mounting member 17 around the yaw axis in a predetermined time period, and determine a second deflection angle of the mounting member 17 around the yaw axis in the predetermined time period based on the gyroscope of the inertial measurement unit 40. The controller 20 may determine an angle error of the gyroscope based on a difference between the first deflection angle and the second deflection angle. The controller 20 may control attitude of the gimbal 1 based on measurement data of the inertial measurement unit 40 in which the angle error has been corrected.

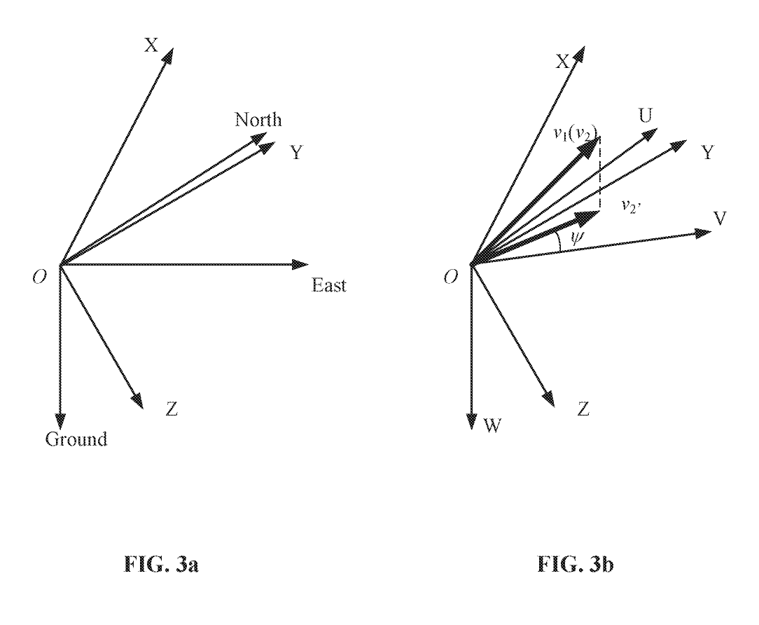

FIG. 3a and FIG. 3b illustrate the principle for determining the angle error of the inertial measurement unit 40. As shown in FIG. 3a, a first coordinate system is assumed to be a Cartesian coordinate system XYZ using the mounting member 17 as a reference. For the convenience of descriptions, an initial facing direction of the Cartesian coordinate system XYZ is assumed to be: the X axis points to the north direction, the Y axis points to the east direction, and the Z axis points to the ground. It is understood that the present disclosure does not limit the initial facing direction of the Cartesian coordinate system XYZ. Because the attitude of the unmanned aircraft changes in flight, the attitude of the mounting member 17 may also change. Accordingly, the pointing directions of the three axes of the first coordinate system XYZ may also change. As shown in FIG. 3a, the three axes of the first coordinate system XYZ have all deflected from their initial facing directions. It is understood that although in the example shown in FIG. 3a the three axes of the first coordinate system XYZ have all deflected from their initial facing directions, according to the present disclosure, it is possible to have only one or two axes deflecting from their initial facing directions. For example, when the mounting member 17 only experience one of roll, pitch, or yaw movements, the first coordinate system XYZ may only have two axes deflecting from their initial facing directions.

As shown in FIG. 3b, the magnetic sensor 30 may measure a first magnetic field intensity v1. The first magnetic field intensity v1 may be represented by three orthogonal components [x, y, z] in the first coordinate system XYZ.

Next, a second coordinate system is introduced. The second coordinate system may be a Cartesian coordinate system UVW. Plane UV may be a horizontal plane. In some embodiments, a rotation status of the second coordinate system UVW around the yaw axis may be the same with that of the first coordinate system. For example, the second coordinate system UVW and the first coordinate system XYZ may synchronously rotate around the yaw axis. The UV plane may be maintained horizontal.

In some embodiments, the controller 20 may convert the first magnetic field intensity v1 to a second magnetic field intensity v2 under the second coordinate system UVW. The amplitude and direction of the second magnetic field intensity v2 may be the same as those of the first magnetic field intensity v1. The second magnetic field intensity v2 may differ from the first magnetic field intensity v1 in that the second magnetic field intensity v2 may be represented by three orthogonal components [u, v, w] under the second coordinate system UVW.

In some embodiments, a value of the second magnetic field intensity v2 may be determined as follows: assuming the UV plane in the second coordinate system UVW rotates an angle ϕ around the U axis, and rotates an angle θ around the V axis to arrive at the first coordinate system XYZ, then:

$${v}_{2} = {R}_{x} ( ϕ ) {R}_{y} ( θ ) {v}_{1} = [ \begin{matrix}u & v & w\end{matrix} ] , where$$

$${R}_{x} ( ϕ ) = [ \begin{matrix}1 & 0 & 0 \\ 0 & cos ( ϕ ) & - sin ( ϕ ) \\ 0 & sin ( ϕ ) & cos ( ϕ )\end{matrix} ]$$

$${R}_{y} ( θ ) = [ \begin{matrix}cos ( θ ) & 0 & sin ( θ ) \\ 0 & 1 & 0 \\ - sin ( θ ) & 0 & cos ( θ )\end{matrix} ]$$

In some embodiments, an accelerometer mounted to the gimbal may be used to obtain the angles θ and ϕ.

In some embodiments, the controller 20 may calculate an angle between a projection v2′ of the second magnetic field intensity v2 on a horizontal plane and the U axis or the V axis of the second coordinate system UVW. For example, as shown in FIG. 3b, the angle between the projection v2′ and the V axis may be obtained as:

$$ψ = atan ( \frac{u}{v} )$$

In some embodiments, after a time period, the magnetic sensor 30 may measure the first magnetic field intensity v1 again. The controller 20 may calculate the angle ψ again based on the measured first magnetic field intensity v1. The controller 20 may compare the two angles ψ to obtain a difference or change. The difference or change may be a rotation angle of the mounting member 17 rotating around the yaw axis in this time period. This rotation angle may be determined as a first deflection angle.

In some embodiments, the controller 20 may determine a second deflection angle of the mounting member 17 rotating around the yaw axis within the time period through the gyroscope of the inertial measurement unit 40.

In theory, the first deflection angle and the second deflection angle should be the same. However, in practice, when zero offset or temperature drifting occurs to the inertial measurement unit 40, the second deflection angle obtained based on the inertial measurement unit 40 may be different from the first deflection angle. In some embodiments, the controller 20 may obtain multiple pairs of the first deflection angle and the second deflection angle in a time sequence. The controller 20 may perform a low-pass filtering to the first deflection angle and the second deflection angle to obtain an angle error of the inertial measurement unit 40, i.e., the angle error of the gyroscope.

In some embodiments, the controller 20 may control the attitude of the gimbal based on the measurement data of the inertial measurement unit 40 in which the angle error has been corrected. For example, the controller 20 may reduce the second deflection angle by the angle error to obtain a corrected second deflection angle, and may use the corrected second deflection angle to control the deflection of the mounting member 17 around the yaw axis.

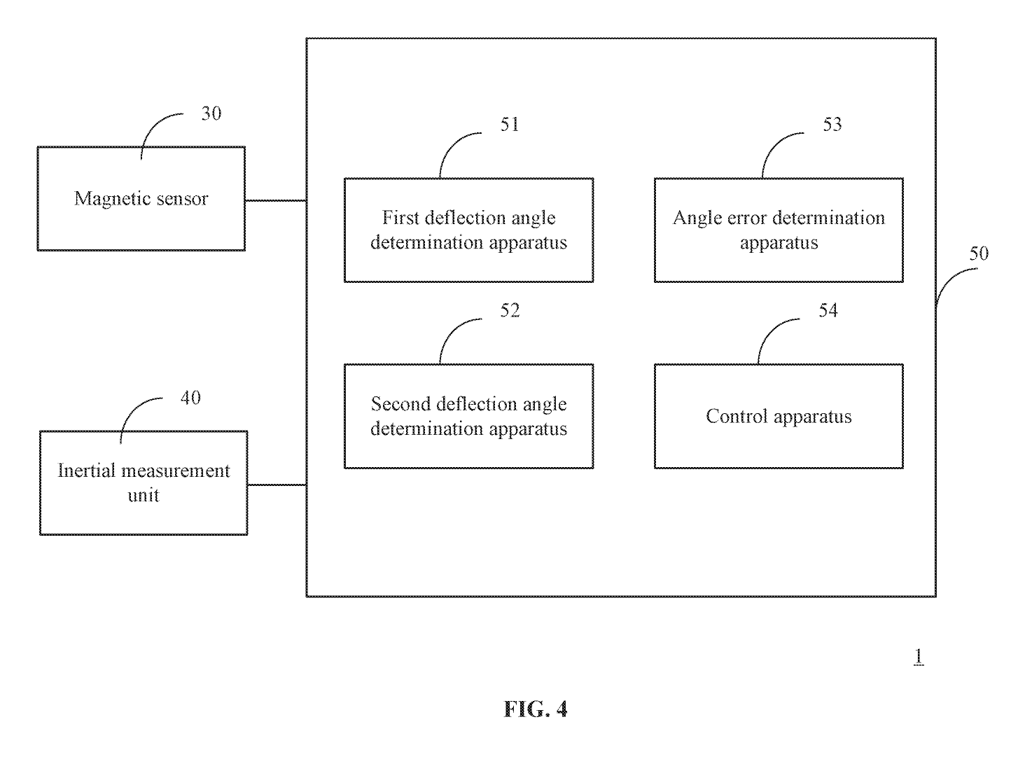

FIG. 4 is a schematic diagram of the gimbal 1. The gimbal 1 may include the magnetic sensor 30, the inertial measurement unit 40, and a control system 50. The magnetic sensor 30 may be mounted to the mounting member 17, or the magnetic sensor 30 and the mounting member 17 may be provided on the same rigid body. For example, the magnetic sensor 30 and the mounting member 17 may be provided on the pitch axis arm 11. The inertial measurement unit 40 may include at least one gyroscope. The inertial measurement unit 40 may be mounted to the mounting member 17, or the inertial measurement unit 40 and the mounting member 17 may be provided on the same rigid body. For example, the inertial measurement unit 40 and the mounting member 17 may be provided on the pitch axis arm 11.

In some embodiments, the control system 50 may include a first deflection angle determination apparatus 51, a second deflection angle determination apparatus 52, an angle error determination apparatus 53, and a control apparatus 54.

In some embodiments, the first deflection angle determination apparatus 52 may be configured to determine the first deflection angle of the mounting member 17 rotating around the yaw axis in a time period based on the first magnetic field intensity v1 obtained by the magnetic sensor 30. The second deflection angle determination apparatus 52 may determine the second deflection angle of the mounting member 17 rotating around the yaw axis in the time period through the inertial measurement unit 40. The angle error determination apparatus 53 may be configured to determine an angle error of the inertial measurement unit 40 based on a difference between the first deflection angle and the second deflection angle. The control apparatus 54 may control the attitude of the gimbal based on the measurement data of the inertial measurement unit 40 in which the angle error has been corrected.

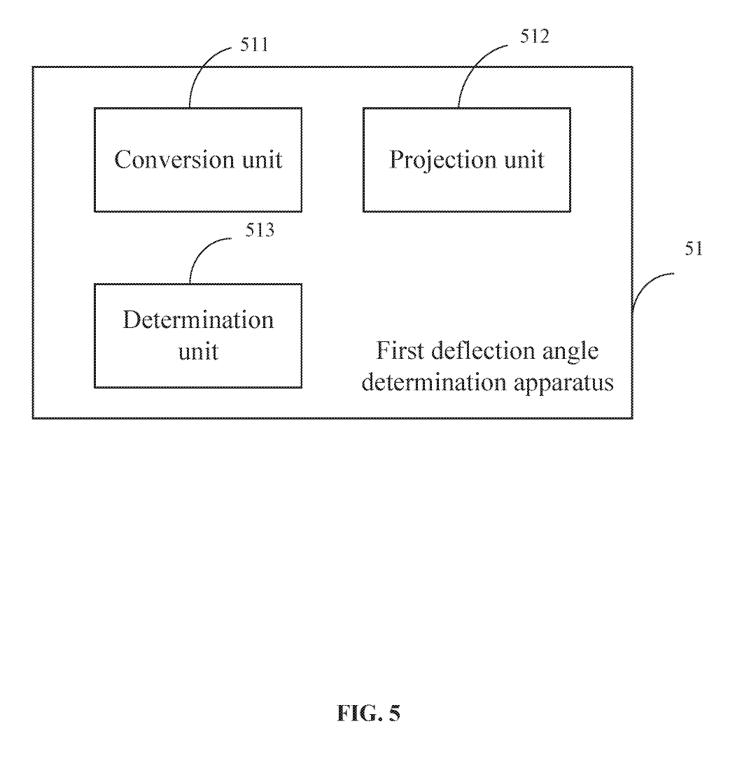

FIG. 5 is a schematic diagram of the first deflection angle determination apparatus 51. The first deflection angle determination apparatus 51 may include a conversion unit 511, a projection unit 512, and a determination unit 513.

In some embodiments, the conversion unit 511 may be configured to convert the first magnetic field intensity v1 from the first coordinate system to the second coordinate system to obtain the second magnetic field intensity v2. The projection unit 512 may be configured to determine a projection of the second magnetic field intensity v2 on a horizontal plane. The determination unit 513 may be configured to determine the first deflection angle based on the projection. The methods for the conversion, projection, and determining the first deflection angle may refer the above descriptions in connection with FIG. 3, which are not repeated.

In some embodiments, the first deflection angle determination apparatus 51 and the second deflection angle determination apparatus 52 may obtain multiple pairs of the first deflection angle and the second deflection angle in a time sequence. The angle error determination apparatus 53 may apply a low pass filtering to the first deflection angle and the second deflection angle to obtain an angle error of the inertial measurement unit 40, which is the angle error of the gyroscope.

In some embodiments, the control apparatus 54 may be configured to control the attitude of the gimbal based on the measurement data of the inertial measurement unit 40 in which the angle error has been corrected. For example, the control apparatus 54 may be configured to correct the second deflection angle based on the angle error to obtain a corrected second deflection angle. The control apparatus 54 may be configured to control the deflection of the mounting member 17 around the yaw axis based on the corrected second deflection angle.

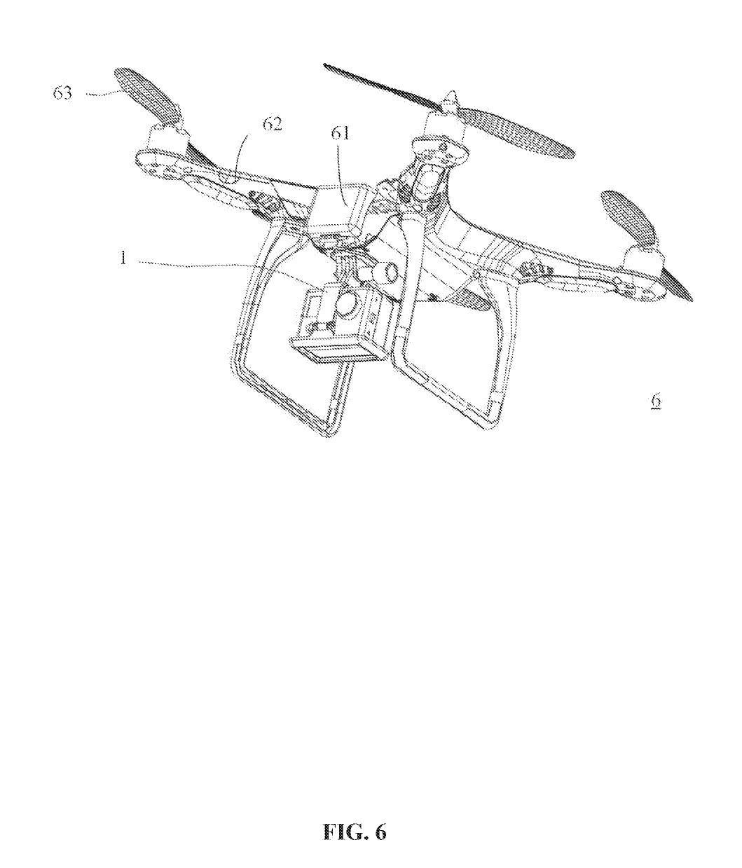

FIG. 6 is a perspective view of an unmanned aircraft 6. As shown in FIG. 6, the unmanned aircraft 6 may include an aircraft body 61 and multiple aircraft arms 62 connected with the aircraft body 61. The aircraft arms 62 may be configured to carry rotor assemblies 63. The unmanned aircraft may include the above-described gimbal 1, which may be mounted to the aircraft body 61.

According to the present disclosure, a computer software may include computer-readable codes or instructions. When the codes are executed by a processor, the processor may perform various operations, methods, or processes described above in connection with FIG. 2, FIG. 3a, and FIG. 3b.

According to the present disclosure, a non-volatile non-transitory storage medium may store computer-readable codes. When the codes are executed by a processor, the processor may perform the disclosed methods.

According to the present disclosure, the angle error of the inertial measurement unit may be corrected based on a direction of a magnetic field, which can effectively suppress the drifting that may occur to the mounting member around the yaw axis, thereby improving the stability of the gimbal.

The method, device, unit, and/or module of the above-described embodiments may be realized through a suitable electronic device having a computing capability executing software including computer-readable codes or instructions. The disclosed system may include a storage device to realize various storage described above. The electronic device having the computing capability may include a specially-designed or programmed processor, a digital signal processor, a dedicated processor, a reconfigurable processor, and other suitable devices that may be configured to process computer-executable codes or instructions. The present disclosure does not limit the type of electronic device. Executing the codes may configure the electronic device to perform various operations, processes, or methods disclosed herein. The above device and/or module may be realized in a single electronic device, or may be realized in different electronic devices. The software may be stored in a computer-readable, non-transitory storage medium. The computer-readable storage medium may store one or more than one software (or software module). The one or more software may include computer-readable (and computer-executable) codes. When one or more processors included in the electronic device execute the codes, the codes may cause the electronic device to perform the disclosed methods.

The software may be stored in a volatile storage device or a non-volatile storage device (such as a read-only memory). The storage device may be erasable or rewritable. In some embodiments, the software may be stored in other storage forms, such as a random-access memory, a storage chip, a device or an integrated circuit, or an optical medium or magnetic medium. In some embodiments, the storage device and storage medium are examples of a computer-readable storage device that may be configured to store one or more computer software programs. The one or more computer software programs may include codes or instructions. When the codes or instructions are executed by a processor, the technical solutions of the present disclosure may be realized. The present disclosure provides a computer software program and a computer-readable storage medium for storing the computer software program. The computer software program may include codes for realizing any of the claimed device or method. The computer software program may be electrically transmitted through any suitable medium (e.g., through a wired or wireless communication signal). One or more embodiments include such computer software program.

In some embodiments, various embodiments of the disclosed method, device, unit, and/or module may be realized using other suitable hardware or firmware, such as FPGA, PLA, system on a chip, system on a substrate, system on a package, ASIC, or other suitable fashion based on circuit integration or packaging. When the present disclosure is realized using the above forms, the software, hardware, and/or firmware may be programmed or designed to execute the above methods, steps, and/or functions. A person having ordinary skills in the art may realize one or more of the systems or modules, or a portion or multiple portions of the systems or modules using different forms. Such realization forms fall within the scope of the present disclosure.

The various embodiments of the disclosed technical solutions and the technical features may be implemented independently or in combination, as long as there is no obvious conflict. Any modification to the disclosed embodiments or combination thereof all fall within the protection scope of the present disclosure as long as such modification and combination do not exceed the knowledge scope of a person having ordinary skills in the art.

A person having ordinary skill in the art can appreciate that the various system, device, and method illustrated in the example embodiments may be implemented in other ways. For example, the disclosed embodiments for the device are for illustrative purpose only. Any division of the units are logic divisions. Actual implementation may use other division methods. For example, multiple units or components may be combined, or may be integrated into another system, or some features may be omitted or not executed. Further, couplings, direct couplings, or communication connections may be implemented using indirect coupling or communication between various interfaces, devices, or units. The indirect couplings or communication connections between interfaces, devices, or units may be electrical, mechanical, or any other suitable type.

In the descriptions, when a unit or component is described as a separate unit or component, the separation may or may not be physical separation. The unit or component may or may not be a physical unit or component. The separate units or components may be located at a same place, or may be distributed at various nodes of a grid or network. The actual configuration or distribution of the units or components may be selected or designed based on actual need of applications.

Various functional units or components may be integrated in a single processing unit, or may exist as separate physical units or components. In some embodiments, two or more units or components may be integrated in a single unit or component. The integrated unit may be realized using hardware or a combination of hardware and software.

If the integrated units are realized as software functional units and sold or used as independent products, the integrated units may be stored in a computer-readable storage medium. Based on such understanding, the portion of the technical solution of the present disclosure that contributes to the current technology, or some or all of the disclosed technical solution may be implemented as a software product. The computer software product may be storage in a non-transitory storage medium, including instructions or codes for causing a processor (e.g., a processor included in a personal computer, a server, or a network device, etc.) to execute some or all of the steps of the disclosed methods. The storage medium may include any suitable medium that can store program codes or instruction, such as at least one of a U disk (e.g., flash memory disk), a mobile hard disk, a read-only memory (“ROM”), a random access memory (“RAM”), a magnetic disk, or an optical disc.

The above embodiments are only examples of the present disclosure, and do not limit the scope of the present disclosure. All equivalent structure or equivalent processes developed or derived based on this specification and the accompanying figures, or any direct or indirect implementations of the disclosed technical solutions in other related technical field, all fall within the protection scope of the present disclosure.

The above embodiments are described to illustrate the technical solutions, and do not limit the scope of the present disclosure. Although the technical solutions are explained with reference to the various embodiments, a person having ordinary skills in the art should appreciate that the technical solutions explained in the various embodiments may be modified, or some or all of the technical features may be replaced with equivalents. Such modification or replacement do not render the relevant technical solution falling out of the protection scope of the present technical solutions.

Other embodiments of the present disclosure will be apparent to those skilled in the art from consideration of the specification and practice of the embodiments disclosed herein. It is intended that the specification and examples be considered as example only and not to limit the scope of the present disclosure, with a true scope and spirit of the invention being indicated by the following claims. Variations or equivalents derived from the disclosed embodiments also fall within the scope of the present disclosure.

What is claimed is:

1. A method for controlling a gimbal including a mounting member, comprising:
determining, through a magnetic sensor, a first deflection angle of the mounting member around a yaw axis in a time period;
determining, through an inertial measurement unit, a second deflection angle of the mounting member around the yaw axis in the time period;
determining an angle error of the inertial measurement unit based on the first deflection angle and the second deflection angle; and
controlling attitude of the gimbal based on measurement data of the inertial measurement unit in which the angle error has been corrected.

2. The method of claim 1, wherein determining, through the magnetic sensor, the first deflection angle of the mounting member around the yaw axis in the time period comprises:
obtaining a first magnetic field intensity through the magnetic sensor; and
determining the first deflection angle based on the first magnetic field intensity.

3. The method of claim 2, wherein the first magnetic field intensity is a geomagnetic field intensity.

4. The method of claim 2, wherein determining the first deflection angle based on the first magnetic field intensity comprises:
converting the first magnetic field intensity from a first coordinate system to a second coordinate system to obtain a second magnetic field intensity,
wherein:
the first coordinate system is a Cartesian coordinate system XYZ, and the second coordinate system is a Cartesian coordinate system UVW,
the first coordinate system uses the mounting member as a reference; and
a UV plane of the second coordinate system is a horizontal plane, and a rotation status of the second coordinate system around the yaw axis is the same as a rotation status of the first coordinate system around the yaw axis;
determining a projection of the second magnetic field intensity on the horizontal plane; and
determining the first deflection angle based on the projection.

5. The method of claim 4, wherein determining the first deflection angle based on the projection comprises:
determining the first deflection angle to be a change in an angle between the projection and a U axis or a V axis of the second coordinate system.

6. The method of claim 1, wherein determining the angle error of the inertial measurement unit based on the first deflection angle and the second deflection angle comprises:
obtaining multiple pairs of the first deflection angle and the second deflection angle based on a time sequence; and
applying a low pass filtering to the first deflection angle and the second deflection angle to obtain the angle error in the inertial measurement unit.

7. The method of claim 1, wherein the angle error comprises a temperature drift or a zero offset of the inertial measurement unit.

8. A system for controlling a gimbal including a mounting member, a magnetic sensor, and an inertial measurement unit, the system comprising:
a first deflection angle determination apparatus configured to determine, through the magnetic sensor, a first deflection angle of the mounting member around a yaw axis in a time period;
a second deflection angle determination apparatus configured to determine, through the inertial measurement unit, a second deflection angle of the mounting member around the yaw axis in the time period;
an angle error determination apparatus configured to determine an angle error based on the first deflection angle and the second deflection angle; and
a control apparatus configured to control attitude of the gimbal based on measurement data of the inertial measurement unit in which the angle error has been corrected.

9. The method of claim 8, wherein the first deflection angle determination apparatus is further configured to:
obtain, through the magnetic sensor, a first magnetic field intensity; and
determine the first deflection angle based on the first magnetic field intensity.

10. The method of claim 9, wherein the first magnetic field intensity is a geomagnetic field intensity.

11. The method of claim 8,
wherein the firsts deflection angle determination apparatus and the second deflection angle determination apparatus are configured to obtain multiple pairs of the first deflection angle and the second deflection angle based on a time sequence, and
wherein the angle error determination apparatus is configured to apply a low pass filtering to the first deflection angle and the second deflection angle to obtain the angle error of the inertial measurement unit.

12. A gimbal, comprising:
a mounting member configured to mount a load device;
a magnetic sensor;
an inertial measurement unit; and
a controller configured to:
determine, through the magnetic sensor, a first deflection angle of the mounting member around a yaw axis in a time period;
determine, through the inertial measurement unit, a second deflection angle of the mounting member around the yaw axis in the time period;
determine an angle error of the inertial measurement unit based on the first deflection angle and the second deflection angle; and
control attitude of the gimbal based on measurement data of the inertial measurement unit in which the angle error has been corrected.

13. The gimbal of claim 12, wherein the controller is further configured to:
obtain a first magnetic field intensity through the magnetic sensor; and
determine the first deflection angle based on the first magnetic field intensity.

14. The gimbal of claim 13, wherein the controller is further configured to:
convert the first magnetic field intensity from a first coordinate system to a second coordinate system to obtain a second magnetic field intensity,
wherein the first coordinate system is a Cartesian coordinate system XYZ, and the second coordinate system is a Cartesian coordinate system UVW,
wherein the first coordinate system uses the mounting member as a reference; and
wherein a UV plane of the second coordinate system is a horizontal plane, and a rotation status of the second coordinate system around the yaw axis is the same as a rotation status of the first coordinate system around the yaw axis;
determine a projection of the second magnetic field intensity on the horizontal plane; and
determine the first deflection angle based on the projection.

15. The gimbal of claim 14, wherein the controller is further configured to determine the first deflection angle to be a change in an angle between the projection and a U axis or a V axis of the second coordinate system.

16. The gimbal of claim 12, wherein the controller is further configured to:
obtain multiple pairs of the first deflection angle and the second deflection angle based on a time sequence; and
apply a low pass filtering to the first deflection angle and the second deflection angle to obtain the angle error of the inertial measurement unit.
